(19) United States
(12) Patent Application Publication
(10) Pub. No.: US 2008/0172555 A1
(43) Pub. Date: Jul. 17, 2008

(54) Bootable thin client personal initialization device

(75) Inventor: Roderick J. Keenan, Newport, KY (US)

Correspondence Address: JAMES C. EAVES JR.;GREENEBAUM DOLL & MCDONALD PLLC, 3500 NATIONAL CITY TOWER, 101 SOUTH FIFTH STREET, LOUISVILLE, KY, 40202, US

(73) Assignee: Erink Technologies, LLC

(21) Appl. No.: 11/821,167

(22) Filed: Jun. 22, 2007

Related U.S. Application Data
(60) Provisional application No. 60/880,792, filed on Jan. 17, 2007.

(51) Int. Cl. G06F 15/177; G06F 7/04

(52) U.S. Cl. 713/2; 709/203; 726/28

(57) ABSTRACT

The invention provides a “thin client”, such as software loaded on a USB memory “stick” or other bootable media, that boots a host machine without using the machine's hard-drive or software and without local applications running in the background. The USB thin client device's use and control of the host machine is safe to the host machine because it does not involve nor alter the hard-drive or software of the machine. The host machine acts like a “dumb” terminal to permit the USB thin client to remotely access a remote server to for example run software and access data remotely for local presentation and interfacing via the host machine's display, keyboard, printer, etc. By using, for example, a broadband Internet connection there is no appreciable delay given today's connection speeds. The USB thin client typically includes a portion in the open and an encrypted portion only accessible after the user, for example, enters a security password. Upon recognition of the password by the USB thin client device, the device decrypts the encrypted portion of the stick, including personal information.

### CROSS-REFERENCE TO RELATED APPLICATION

The present patent application claims the benefit of U.S. provisional patent application Ser. No. 60/880,792 filed Jan. 17, 2007 entitled Bootable Thin Client Personal Initialization Device, the entirety of which is hereby incorporated by reference.

### FIELD OF THE INVENTION

The invention generally relates to devices, systems and methods for using a local or borrowed device, a host machine, to remotely connect to a remote server, computer or other software processing device, such as an application server (e.g., serving Linux or Windows and desktops supporting various applications)

### BACKGROUND OF THE INVENTION

In past systems such as centralized processing mainframe/dumb terminal architecture, the software put in use by the user operated on a mainframe and was then presented to the user via a dumb terminal, for example. If the central mainframe was inoperable or severed from the dumb terminal, then there could be no processing of software and data. The migration away from centralized processing to distributed processing led to the widespread adoption of personal computers “PCs”. With PCs, each user is typically required to have a license for the software running locally on the machine. PCs communicate with each other and other system devices via a network, such as a LAN (local area network) or WAN (wide area network). Security is a critical aspect of any system and includes the protection of sensitive data from unauthorized access and the protection of data, devices and software from corruption or from outside interference. More recently, the use of Universal Serial Bus (USB) memory sticks having flash memory as a portable drive has become widely adopted. Platforms for combining memory sticks with secure elements and/or software applications, such as SanDisk's U3 initiative, have been launched but typically include the memory device having the software for remote processing present on the device itself. Although the price of memory is historically on a downward curve, the requirement of memory for applications and operating systems is on an upward curve. Previous attempts (e.g., PC Anywhere, emulation software, No Machine, U3, USB drives with applications) to address some of the needs addressed by the present invention (e.g., security, portability, versatility, efficiency, economy, performance) fall short of addressing all such needs.

### SUMMARY OF THE INVENTION

The invention provides a “thin client”, such as software loaded onto a USB memory “stick” or other bootable media, that literally boots a host machine without using the machine's hard-drive or software and without local applications running in the background. The USB stick's use and control of the host machine is safe to the host machine because it does not involve nor alter the hard-drive or software of the machine. The host machine acts like a “dumb” terminal to permit the USB thin client to remotely access a remote server to for example run software and access data remotely for local presentation and interfacing via the host machine's display, keyboard, printer, etc. By using, for example, a broadband Internet connection there is no appreciable delay given today's connection speeds. The USB thin client typically includes a portion in the open and an encrypted portion only accessible after the user, for example, enters a security password. Upon recognition of the password by the USB thin client device, the device decrypts the encrypted portion of the stick, including personal information. The thin client contains system data files used by the system to operate but typically contains no user data files.

In one embodiment, the thin client would not contain proprietary software, but rather only drivers to support a defined set of hardware or for a generally known and common set of publicly available hardware. The thin client using the drivers would run an initial process of recognizing and configuring the local host computer and its related components and peripheral equipment. The requirements at the local host machine, for example, could be an x86 type processor, video card, sound card, Ethernet/time clock, etc. The thin client can be configured to boot a device given a LINUX OS/KDE environment or any other applicable operating system and applications. While the discussion may focus on the host machine being a computer, as adoption of technology across device platforms blurs traditional device functionality it is fully contemplated that the invention may be used with other equipment, e.g., mobile telephony. The open source software loaded onto the thin client may include altered open source shell scripts, but the essential source code preferably is not modified. The invention may utilize, for example, Ethernet or DHCP protocols and may work in an open network or in a closed network with a dialog box permitting a user to logon to a secure system.

In one exemplary embodiment, the present invention provides a method for booting and operating a personal computing device comprising a processor and storage device. The method comprises the following steps: operatively coupling a removable thin client device with a deactivated personal computing device; activating the personal computing device with the thin client device coupled thereto whereby the thin client device operates a processor of the personal computing device; and booting the personal computing device causing the processor to load an operating system contained on the thin client device without invoking a storage device or any operating system or application software contained on the personal computing device. In addition, the booting step may comprise loading a boot code contained on the thin client device and causing the processor to initiate a boot sequence using the thin client boot code and invoking any necessary BIOS or firmware required of the personal computing device at boot time. In addition, the thin client device may comprise non-volatile memory and the boot code and the operating system is stored in the non-volatile memory; a USB memory stick; or a compact disk. The personal computing device may be adapted to communicate over a network and the thin client device causes the personal computing device to initiate a connection with a network. The network may be at least one of the Internet or an intranet. The thin client device may cause the personal computing device to access a remote application server; may cause the personal computing device to display on a display associated with the personal computing device a remote application running on the remote application server, whereby a user can interact with the remote application by using one or more devices associated with the personal computing device. The one or more devices associated with the personal computing device may be at least one of a group consisting of a keyboard and a mouse. The user may interact with the remote application to perform one or more of the following tasks: access data, input data, access documents, create documents, access files, create files, run reports, print documents, edit files, edit documents, save data, save documents, save files, and operate remote devices. The remote application server may comprise at least one remote peripheral device and the performed tasks are performed at least in part on the at least one remote peripheral device. The remote peripheral device may be one or more of: printing device; storage device; database; sensor device, alarm system; and security system. The thin client device may include driver code for operating devices associated with the personal computing device, the driver code being executed by the processor to operate devices associated with the personal computing device. The booting step may comprise presenting a user with a security process residing on the personal computing device. The step of operatively coupling a removable thin client device with a deactivated personal computing device may be achieved by one of either wirelessly or physical connection. The physical connection may be achieved by a USB connector on the thin client device and a USB port on the personal computing device. The personal computing device may be one of a personal computer, a personal digital assistant, a game console, and a cell phone.

In another exemplary embodiment, the present invention provides a removable thin client device for booting and operating a personal computing device comprising a processor and storage device. The thin client device comprises: means for removably coupling the thin client device with a deactivated personal computing device; non-volatile memory for storing boot code and an operating system; and the boot code adapted to operate a processor of the personal computing device upon activation of the personal computing device and causing the processor to load the operating system without invoking a storage device or any operating system or application software contained on the personal computing device, thereby booting the personal computing device. In addition, the boot code may comprise a bootstrap loader and is loaded in an operating memory of the personal computing device and the boot code causes the processor to invoke any necessary BIOS or other firmware of the personal computing device to place the personal computing device in a useful operating state. The removable thin client device may also include means for cooperatively interacting with a security routine residing on the personal computing device. The removable thin client device may include a secure portion and an un-secure portion, and the secure portion may be accessible only after a security input is input by the user using the personal computing device. The secure portion may be encrypted and decrypted only after the security input is input and recognized by code contained in at least one of hardware and the un-secure portion of the thin client device. A separate device may be coupled with the personal computing device so that the processor recognizes the thin client device prior to booting.

### BRIEF DESCRIPTION OF THE DRAWINGS

In order to facilitate a full understanding of the present invention, reference is now made to the accompanying drawings, in which like elements are referenced with like numerals. These drawings should not be construed as limiting the present invention, but are intended to be exemplary and for reference.

FIG. 1 is a schematic view illustrating a first embodiment of the present invention.

FIG. 2 is a schematic view illustrating alternative connections associated with the present invention.

### DETAILED DESCRIPTION OF INVENTION

The present invention will now be described in more detail with reference to exemplary embodiments as shown in the accompanying drawings. While the present invention is described herein with reference to the exemplary embodiments, it should be understood that the present invention is not limited to such exemplary embodiments. Those possessing ordinary skill in the art and having access to the teachings herein will recognize additional implementations, modifications, and embodiments, as well as other applications for use of the invention, which are fully contemplated herein as within the scope of the present invention as disclosed and claimed herein, and with respect to which the present invention could be of significant utility.

The present invention thin client Personal Initialization Device (PID) allows a user to boot a computer with software in the possession and control of the user and known by that user to be secure. The thin client PID boots the borrowed device, such as a personal computer, cell phone, personal digital assistant (PDA), or other software processing device, with full control over the host computer. To use a kiosk, Internet café machine or other machine that has already been booted by someone else would not be secure. The invention provides security by booting a host machine with software known and in the control of the user. The invention also provides security to the host machine because the thin client does not access files on the host machine. In one embodiment, all of the software running on the local host machine has been booted from the thin client PID device. Any other software or devices utilized or connected to, whether on the local host machine or across the Internet, is under the control of the thin client PID device and it can determine or control whether that access is secure or not. Once the local host machine is booted, the PID device has control over whatever else gets executed by the machine.

Initializing the host computer with the PID device, e.g., a USB memory stick, includes the process of configuring all the local host machine hardware and peripheral components connected to the device. For instance, in the case of a laptop the PID configures the keyboard and mouse, video card, CD Rom drive and other local devices connected to the machine. It in effect makes them usable by the local user.

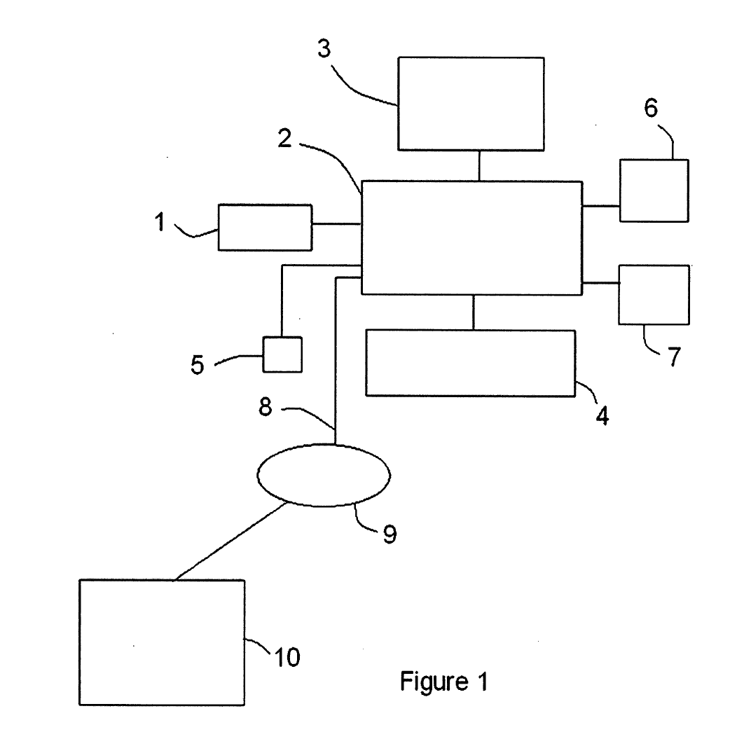

With reference to FIG. 1, PID or USB PID is indicated with reference number 1. PID 1 couples or connects through the USB port of a local host machine 2, such as for example a PC, x86 type processor driven machine, or PowerPC (PPC) type machine. Coupling of the PID with the machine may be accomplished wirelessly or in a number of different ways and is not critical to the invention. Although machine 2 is used herein and described as a computer, it is not so limited and may be any electronic appliance that may serve as a terminal to the Internet or other network and having the processing and other capabilities requisite to practice the invention and could include game consoles, cell phones, PDAs. In at least one application the PID serves to make machine 2 operate as a remote desktop.

It should be understood that the invention may be used in conjunction with any bootable device and one of the key aspects to this is the portability of the thin client. Another example of such a device is an SD or SSD card or solid state storage device such that a storage device, e.g., compact flash based device, used in a camera may be configured to boot a computer. In addition, the same or different PID used to initialize a host PC machine 2 could be used to initialize a cellular phone. The process by which the USB PID 1 boots up the local host machine 2 using software embedded on the USB PID is to the exclusion of any software on the local host machine. Normally when a user turns on host machine 2 it is set to boot from its hard drive where the machine 2 BIOS (Basic Input Output System) goes to the hard disk and invokes software to boot off the hard disk. Also most computers are set up that if a user puts a bootable CD ROM in the drive, that will boot in front of the machine hard drive. In other words the machine may boot from either the CD ROM drive or the hard drive. In the case of the present invention the machine boots from the PID 1, e.g. via the USB port. When plugged in via the USB port the machine 2 must recognize the PID 1 as a removable drive and the machine internal BIOS would need to be directed either to choose the USB device as the boot device, which most modern BIOSs are set to do, or to boot the machine from the CD ROM drive. In the latter case a CD ROM would be supplied along with the PID that will then locate the USB PID 1 and further initialize the machine 2. In this case the CD ROM would load a kernel to find the USB PID to start the machine.

Also, a CD ROM may be used in conjunction with a Macintosh type computer from Apple Computer, Inc. and such a process could entail informing the PID that it is being connected to a Macintosh computer loading appropriate Macintosh compatible code. This applies to any RISC/ARM processor based devices.

In any event, the machine 2 is booted from software contained on the PID 1 and independent of anything that would be contained on any hard drives from within the host machine 2. In this manner the PID 1 ignores the hard drives built into the host machine 2 and avoids using any of the software contained on the hard-drive and is not dependent upon any software that's contained upon the hard drives to operate. This has the additional benefit of providing the host machine owner with the security that none of the software or memory on the host machine will be disturbed by the PID 1. So the booting process is totally independent of the hard drives but once the machine is booted up, all other hardware on the machine is identified and configured properly such as network cards, video cards, mice, CD ROM drives, other USB devices and so on. It would be appreciated by one of ordinary skill in the art that virtualization and other techniques, such as segmenting processors or using multiple parallel processors, may allow the computer to be “on” but still separately bootable by the PID and operable in isolation from the software stored on the machine.

With reference to FIG. 1, for the purpose of connecting to a remote server/computer/desktop 10, PID 1 utilizes a network connection 9, such as via the Internet, and may utilize devices or components and/or peripherals connected to the machine 2, for example a keyboard 4, a mouse 5 and a display or screen 3. The user may also utilize hardware and devices such as a removable storage device 6, e.g., CD ROM, a printer 7, or other devices while using the host machine 2 via the PID 1 to replicate the experience of operation at remote machine 10. Applications include a worker connecting via a home computer to an office server, the remote machine could be a VOIP (voice over IP) server, and a browser may be used to access a remote application. PID 1 may include drivers to common hardware and other equipment and can configure such devices by using current open source automatic configuration tools that poll for hardware to determine what hardware is located on or connected to the machine 2. And the machine 2 responds back to PID 1 indicating the nature and type of hardware, such as a CD ROM drive 6, a video card and so on. And as that information is polled from the machine 2, software contained on the PID 1 recognizes the proper drivers to be installed for that hardware and it installs them on the machine 2 from code contained on the PID 1. Preferably, the PID 1 includes the majority of commonly used drivers for equipment that would be either in the machine at boot time or plugged into the machine later such as cameras and things that would plug into the USB port. For instance, the PID 1 could include software to support all the hardware that is currently supported by Linux. The PID 1 could include sufficient memory to support the vast majority of commercial hardware or off the shelf equipment.

Using the Linux example, some of the drivers within Linux are kernel modules that are actually built into the Linux kernel. Some of them are third party drivers from other open source projects and so on. The PID device has the capability to recognize that the hardware can install the proper driver for it. Whether it be from the kernel or as an external module.

The booting process consists of initializing all of the hardware that is connected to the machine, installing the proper drivers and making them available to the user with the exception of the local hard drives. In an alternative embodiment, the PID could allow a user local access to the local hard drives.

Some computers, when first going through the booting up process, may require a password. For instance, company issued notebooks may require a user to type in a password to get access to the device. The majority of passwords come from the software that is being booted off of the hard drive. Normally when turning on the machine it boots from the hard drive as usual and the operating system or some sort of security software on that hard drive will present the user with that password requirement. Since PID 1 bypasses the hard drive and directly boots the machine it avoids this. For hardware security mechanisms built into the BIOS or if the BIOS required a password then the user would need to know the password to properly boot the machine unless the PID were otherwise recognized and permitted operation.

One of the first things that happens in the boot process is the PID asks the user for the PID password. The PID password opens up the encrypted portion of the PID. On the PID there is one portion that is “open” in what is called plain text. It is not encrypted at all and that's the boot portion. That is just the minimum that needs to be done before decrypting encrypted data. The software that asks for the password is an example of software contained on the PID that is “in the open” because nothing's been decrypted yet. Once the PID password is entered, then the device decrypts the portion of the disk that contains all of the personal information and all of the software that operates on that information and then boots into that encrypted portion of the PID. The boot portion that's in the open presents the user with a request for a password that then allows access to the encrypted portion. The software that asks for the password and then decrypts the encrypted portion has to, of course, be in the open itself.

The security password software that is used may be made up of a number of open source packages. The top level package that's been used, for example, is called “cryptsetup-LUKS” and it uses what's called a Linux Unified Key System. But underneath that, like all open source projects, is a number of packages. Cryptsetup is just the top portion that uses other Linux packages, open source devices beyond Cryptsetup and data mapping and so on that all lie underneath it along with the encryption mechanisms, for example AES 128/256 and Blowfish and SHA 256 and all the normal encryption mechanisms.

AES 256 or SHA 256, for example, may be used to encrypt and decrypt the PID. Many encryption/decryption mechanisms may be made available on the PID, but the PID itself in the booting process only uses a subset of them.

In decrypting info on the PID to boot into that encrypted portion, once the password is given the software on the PID is used to decrypt the other partition, which means that it mounts it as a normal disk drive but an encryption mechanism is placed between it and the user. So that anything that is read from the drive is read from the unencrypted partition and turns into open text to the user and anything that is written to the drive goes through the encryption mechanism and ends up as encrypted on the drive. That is happening at all times. Everything that is written to or read from the drive goes through the encryption mechanism so that it ends up on the PID device encrypted. The PID is a block device that can be formatted and have a file system put on it.

The PID formation process may start with taking a blank, off the shelf, USB device and then install both open and encrypted portions of the software on it. Initialize the device by first writing on random numbers to the complete device and then partitioning it into two partitions, one for the open partition and one for the encrypted partition and formatting both of those portions and copy the appropriate software to them. The open portion essentially includes just the kernel, i.e., the main piece of the operating system, it's the first thing that boots and it controls everything else, for example Linux. However, the invention is not limited to any particular operating system. What is used to boot the PID and bring up a desktop and configure a mouse and so on so that a user can connect out to the world could be open source Linux products or proprietary systems. The machines that are connected out to can be anything. Also the software that is used on the PID could theoretically be anything that provided encryption and provided a desktop and automatic configuration and so on. Theoretically it could be any operating system.

Also in the open portion, for example, is GRUB, GRand Unified Boot Loader, or some other Boot Loader such as ISOLINUX, which is the software that initiates the booting of the device and machine. The machine looks at the master boot record of the PID and that's where it finds the boot loader. The boot process is called a boot strap because it actually starts out with very small pieces and keeps adding to it. And the boot loader gets loaded first and then it's the boot loader that actually loads the kernel and that is essentially all that is on that open portion is the boot loader and the kernel.

Everything else is on the encrypted portion. The PID may use, for example, either of two common Linux desktops—KDE or GNOME. Applications are provided to connect out. The PID includes all the software needed to connect to the Internet, whether it be through WIFI or Ethernet or EVDO, pretty much any way to connect to the Internet. The PID may include a standard KDE browser and may also include a Java based browser. The PID may include applications to connect remotely to and operate other computers and can operate PCs and Linux. Preferably, the PID has the capability of allowing the remote applications connected to use all the local resources, all the local hardware resources. For instance, when operating with Open Office on a remote computer, a user can print to a local printer or upload from the local USB drive, CD Rom, or PID. A user could upload to the remote server/computer from a local camera to a remote software. Everything used to operate the device is on the encrypted portion, except for the kernel. All of the drivers are on there, all of the drivers that aren't built into the kernel are in that portion, all the configuration software, the network connection software, the NX software, remote connections, the VOIP software, the encrypted mechanisms. The crux of the device is to configure the local hardware and to make the connection to the Internet and then once connected to the Internet allow the user to use software and data remotely across the Internet for local display and interaction.

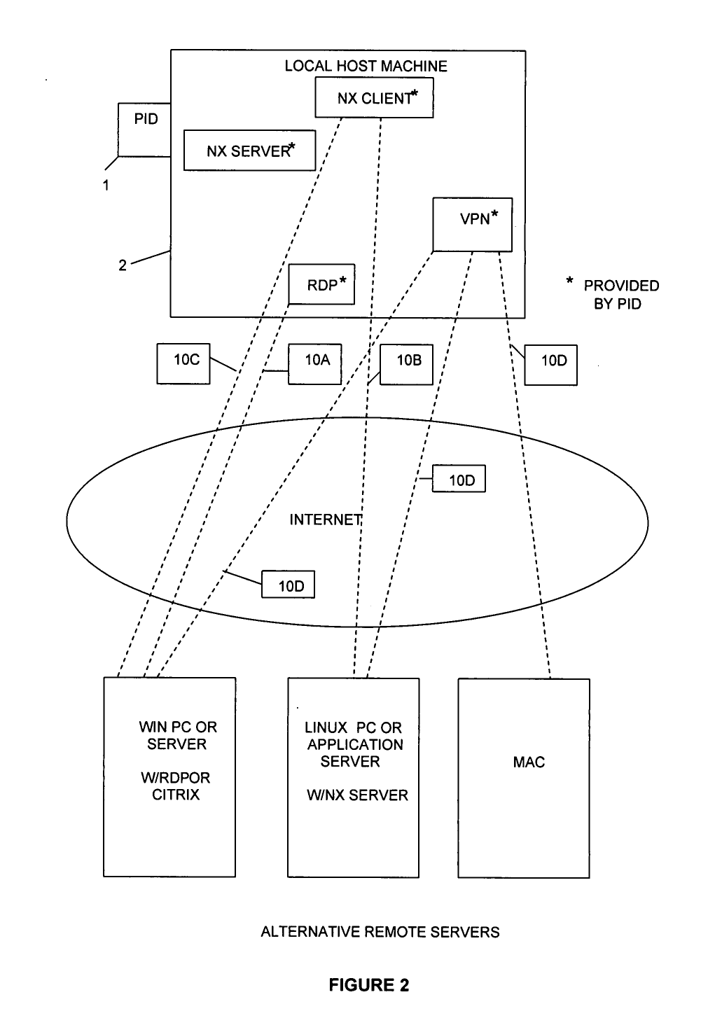

The PID configures the local host machine to connect to a network, such as the Internet, to call or access a remote server or computer, such as an application server. The remote server could be an application server that serves up Linux desktops or it could serve up Windows desktops; it could be a Windows PC with Windows XP Pro installed. Now with reference to FIG. 2, there are various ways by which the PID 1 may connect to the remote computer, for example see the alternative remote server arrangements 10A-10D, depending upon what it is connecting to. The PID 1 provides a direct connection to Windows desktop computer 10A using what Windows calls RDP (remote desktop). The PID 1 also provides NX client software that provides connection to a machine that is running the NX server software 10B. The PID 1 also includes the NX server software to connect to a Windows machine using the local NX server 10C. A virtual private network VPN may be used to connect to a Mac or other computers 10D. With the NX Server application running on the remote server 10C and the NX client application running on the local host machine 2, there is greater performance and efficiency because of the NX server caching technology. In contrast the arrangement of remote server 10A is not very efficient because it uses a Windows mechanism RDP that is not as efficient as NX software. It should be understood that one possessing ordinary skill in the art will appreciate a variety of known protocols may be used to allow shared communication between local operating system running at local host machine 2 and a remote server operating system, e.g., NX, VPN, VOIP, HTTP, RDP, and socket to name a few.

As in all examples, the remote server can be serving a number of different things. Serving remote desktops is but one example. In this example, a user connects via the local host machine to the remote server serving up the desktop and that desktop appears at the local host machine just as if the application running on the remote server were running locally. The user can operate the local host computer to operate the remote server just as if the user were sitting at the remote server displaying the desktop.

One example of a remote Windows desktop server is Citrix. There is momentum towards the remote connection paradigm. For example, Google has introduced offering up applications online. The PID 1 can configure the local host machine to connect through the browser to access applications running at the Google site, e.g., Google word processors and spreadsheet and accounting applications. Google, Microsoft and other sites may offer one or more free versions and proprietary versions. Microsoft and other companies may start to offer either applications or full desktops online. A user can with any compatible browser go to a website, such as Google, and use software through the browser that is similar to Microsoft Word, Excel, Outlook, Access and so on. In this manner, the data may be stored at the website and the user may go in and open up the account and launch licensed software and access authorized data. This may be the beginning of a paradigm shift back toward the days of the mainframe, where huge computers were connected to basic or dumb terminals. The migration away from that centralized processing and to today's distributed processing with PCs may be taking a turn back toward centralized processing. Much of this may be attributed to the tremendous strides in expansion of available bandwidth. This has the benefit of reducing licensing at every distributed PC, maintenance of processing power at a central location, maintenance of data at a central location, and other advantages.

One advantage to using the PID is that it would give added security on the local machine in that there would be no “tracks” of what was done online. Nothing would be left on the local machine. An example of this is an Internet café, someone else's cubical or home computer, a business lounge or room in a hotel or wherever a user happens to use a local host computer. The PID avoids any footprint of what the user did online from being left on a local machine. Because transactions in the open, for example with Google, are not presently secure, Google and such services may start to offer a proprietary or professional level where a user pays a fee to have all information encrypted.

In one scenario, Microsoft may license access to Windows desktop and applications via a secure connection instead of licensing its software to reside on PCs. Microsoft could have application servers accessed remotely to provide a service instead of licensing software to a multitude of employee workstations/PCs. In essence moving the applications off the desk. In the application server paradigm the software resides centrally on applications servers and employees access the software from whatever desktop they choose at a company facility or for that matter remotely at home or elsewhere.

In the connection phase the PID is plugged into the USB port of the local host machine prior to starting up the machine. The machine boots through the software on the PID via the USB port and goes through the boot portion, the security, the password. Once into the encryption/decryption phase/portion the user is are ready to access the remote application server. The next step is to establish (1) the Internet connection and (2) the connection to the application server. The Internet connection is established by the software recognizing the local machine Internet connection location if possible. In other words, if it gets an Ethernet connection, it can tell if it has been connected to this Ethernet before. If it gets a WiFi connection, it can tell if it has been connected to that WiFi before. If it has been connected to these devices before, it will set up the fastest of the ones that it finds. If both WiFi and Ethernet connections are available, the PID will choose the fastest connection. And if the PID has already established connections with these before and used the log in and password it may also automatically use those. If no Internet connection is recognized as being connected before, then the PID tries to get a standard vanilla Ethernet connection using what is called DHCP. The PID asks the server for an IP address and logs onto the network as anonymous, which is a standard Ethernet connection. If that is not available, then it may pop up a window asking the user how to connect by presenting available interfaces. If Ethernet is available that will be listed and so on. The user chooses the Internet, the interface and, if required, enters user name and password. Preferably, after this the PID will recognize that connection and remember it next time and do it automatically for the user.

Upon establishing an Internet connection, the software accesses a clock or the like to set the system time correctly. Preferably, when booting up on a machine or location previously booted from, i.e., on a machine booted up on before, the Internet connection booted up before, the booting process will occur before the initial screen comes up for display to the user. The Internet connection will be established, the time set and so on. Connecting from machine to machine means that the PID is unaware of what the hardware clock is set on each successive machine. Accordingly, the PID obtains time data from the Internet to use in the system. The PID does not affect the hardware clock of the local host machine. The user is free to use the Internet and may bring up the NX software to connect to the remote server, or to bring up the local browser to go to Google, for example, or to bring up the VOIP software to make a phone call and other things to do on the Internet.

Once connected up to the desktop with an Internet connection, then the local host machine appears to operate like any other computer desktop. It will look like a Windows or LINUX desktop, a standard KDE desktop with a menu for selecting applications to launch. A user would bring up the NX software and it has a Wizard that the user goes through and enters the IP address of the remote machine to connect to and information about user name and password on that machine and the information about connecting to that machine. Once that is set up then the user clicks on that the icon that is created and it automatically connects to the remote machine. Even on a slow connection this only takes on the order of 10 seconds. If the user is presented with a password to log onto the machine, then the user would log in as normal as if sitting at the keyboard of that machine.

Once logged in the user can make that remote screen the full screen of the local host machine desktop so that it operates exactly as if the user were sitting at the desktop of the remote machine. Also, the user could have the IP address and so forth all stored on the PID so that the user is prompted and the screens automatically pop up.

In addition, an alternative Personal Desktop Server Device (PDSD) provides additional functionality. A PDSD, for purposes of description, is a CDROM, USB memory device or other device that interfaces to a device such as a personal computer to provide remote access via the internet. In one exemplary embodiment, when a USB-type PDSD device is inserted into a USB port on an already booted Windows machine, the PDSD presents the user with a dialog box asking if remote access is desired. If approved by the user, or authorized owner/provider of the machine, the PDSD can provide a remote interface, accessible through the internet. In this manner, the user can access and operate a computer desktop remotely as if sitting at the keyboard of the remote machine.

The PDSD could work with Windows, Linux, or other operating systems (OS). It requires that the OS be already installed and maintained such that the computer has the proper internet access through methods standard to the OS. In one embodiment the PDSD is read-only and does not contain sensitive or personally identifiable information. All operational files and cache files are kept on the local (host) machine that it's plugged into, which makes it completely portable between people and machines with no risk of information leakage.

The PDSD may provide an option to register the current IP address of the target “home” or “desk” or “office” machine on various dynamic internet addressing services. This allows the user to access the home machine remotely by using a known alias for the machine's internet address, such as mybox.myplace.com, instead of the cryptic internet addressing protocol made up of numbers and dots. Once the PDSD is active and online, the user can operate the host machine remotely using various remote access software such as Remote Desktop Protocol (RDP) or NX client software on the remote machine.

The PDSD would be particularly useful to connect machines that do not have remote access or RDP capability. Such machines would not be able to operate using the embodiments of the PID described above. In one example, the PDSD acts as an NX server for such machines to provide the connectivity, although not necessarily NX. Read-only software may be loaded on the stick to provide the service of the server but caching etc stays on the local machine.

The present invention is not to be limited in scope by the specific embodiments described herein, It is fully contemplated that other various embodiments of and modifications to the present invention, in addition to those described herein, will become apparent to those of ordinary skill in the art from the foregoing description and accompanying drawings. Thus, such other embodiments and modifications are intended to fall within the scope of the following appended claims. Further, although the present invention has been described herein in the context of particular embodiments and implementations and applications and in particular environments, those of ordinary skill in the art will appreciate that its usefulness is not limited thereto and that the present invention can be beneficially applied in any number of ways and environments for any number of purposes. Accordingly, the claims set forth below should be construed in view of the full breadth and spirit of the present invention as disclosed herein.

What is claimed is:

1. A method for booting and operating a personal computing device comprising a processor and storage device, the method comprising:
operatively coupling a removable thin client device with a deactivated personal computing device;
activating the personal computing device with the thin client device coupled thereto whereby the thin client device operates a processor of the personal computing device; and
booting the personal computing device causing the processor to load an operating system contained on the thin client device without invoking a storage device or any operating system or application software contained on the personal computing device.

2. The method of claim 1, wherein the booting step comprises loading a boot code contained on the thin client device and causing the processor to initiate a boot sequence using the thin client boot code and invoking any necessary BIOS or firmware required of the personal computing device at boot time.

3. The method of claim 2, wherein the thin client device comprises non-volatile memory and the boot code and the operating system is stored in the non-volatile memory.

4. The method of claim 1, wherein the thin client device comprises a USB memory stick.

5. The method of claim 1, wherein the thin client device comprises a compact disk.

6. The method of claim 1, wherein the personal computing device is adapted to communicate over a network and the thin client device causes the personal computing device to initiate a connection with a network.

7. The method of claim 6, wherein the network is at least one of the Internet or an intranet.

8. The method of claim 6, wherein the thin client device causes the personal computing device to access a remote application server.

9. The method of claim 8, wherein the thin client device causes the personal computing device to display on a display associated with the personal computing device a remote application running on the remote application server, whereby a user can interact with the remote application by using one or more devices associated with the personal computing device.

10. The method of claim 9, wherein the one or more devices associated with the personal computing device are at least one of a group consisting of a keyboard and a mouse.

11. The method of claim 9, wherein the user interacts with the remote application to perform one or more of the following tasks: access data, input data, access documents, create documents, access files, create files, run reports, print documents, edit files, edit documents, save data, save documents, save files, and operate remote devices.

12. The method of claim 11, wherein the remote application server comprises at least one remote peripheral device and the performed tasks are performed at least in part on the at least one remote peripheral device.

13. The method of claim 12, wherein the at least one remote peripheral device is one or more of: printing device; storage device; database; sensor device, alarm system; and security system.

14. The method of claim 1, wherein the thin client device comprises driver code for operating devices associated with the personal computing device.

15. The method of claim 14, wherein the driver code is executed by the processor to operate devices associated with the personal computing device.

16. The method of claim 1, wherein the booting step comprises presenting a user with a security process residing on the personal computing device.

17. The method of claim 1 further comprising entering a password prior to loading the operating system.

18. The method of claim 1 wherein operatively coupling a removable thin client device with a deactivated personal computing device is achieved by one of either wirelessly or physical connection.

19. The method of claim 18 wherein the physical connection is achieved by a USB connector on the thin client device and a USB port on the personal computing device.

20. The method of claim 1 wherein the personal computing device is one of a personal computer, a personal digital assistant, a game console, and a cell phone.

21. A removable thin client device for booting and operating a personal computing device comprising a processor and storage device, the thin client device comprising:
means for removably coupling the thin client device with a deactivated personal computing device;
non-volatile memory for storing boot code and an operating system; and
the boot code adapted to operate a processor of the personal computing device upon activation of the personal computing device and causing the processor to load the operating system without invoking a storage device or any operating system or application software contained on the personal computing device, thereby booting the personal computing device.

22. The removable thin client device of claim 21, wherein the boot code comprises a bootstrap loader and is loaded in an operating memory of the personal computing device and the boot code causes the processor to invoke any necessary BIOS or other firmware of the personal computing device to place the personal computing device in a useful operating state.

23. The removable thin client device of claim 21 further comprising means for cooperatively interacting with a security routine residing on the personal computing device.

24. The removable thin client device of claim 21, wherein the thin client device comprises a USB memory stick.

25. The removable thin client device of claim 21, wherein the thin client device comprises a compact disk.

26. The removable thin client device of claim 21, wherein the personal computing device is adapted to communicate over a network and the thin client device causes the personal computing device to initiate a connection with a network.

27. The removable thin client device of claim 26, wherein the network is the Internet.

28. The removable thin client device of claim 26, wherein the thin client device causes the personal computing device to access a remote application server.

29. The removable thin client device of claim 28, wherein the thin client device causes the personal computing device to display on a display associated with the personal computing device a remote application running on the remote application server, whereby a user can interact with the remote application by using one or more devices associated with the personal computing device.

30. The removable thin client device of claim 29, wherein the one or more devices associated with the personal computing device are at least one of a group consisting of a keyboard and a mouse.

31. The removable thin client device of claim 29, wherein the user interacts with the remote application to perform one or more of the following tasks: access data, input data, access documents, create documents, access files, create files, run reports, print documents, edit files, edit documents, save data, save documents, save files, and operate remote devices.

32. The removable thin client device of claim 31, wherein the remote application server comprises at least one remote peripheral device and the performed tasks are performed at least in part on the at least one remote peripheral device.

33. The removable thin client device of claim 32, wherein the at least one remote peripheral device is one or more of: printing device; storage device; database; alarm system; and security system.

34. The removable thin client device of claim 21, wherein the thin client device comprises driver code stored on the non-volatile memory and adapted to operate devices associated with the personal computing device.

35. The removable thin client device of claim 34, wherein the driver code is executed by the processor to operate devices associated with the personal computing device.

36. The removable thin client device of claim 21, wherein the non-volatile memory comprises a secure portion and an un-secure portion.

37. The removable thin client device of claim 36, wherein the secure portion is accessible only after a security input is input by the user using the personal computing device.

38. The removable thin client device of claim 37, wherein the secure portion is encrypted and is decrypted only after the security input is input and recognized by code contained in at least one of hardware and the un-secure portion of the thin client device.

39. The removable thin client device of claim 21, wherein a separate device is coupled with the personal computing device so that the processor recognizes the thin client device prior to booting.
